(19) United States
(12) Patent Application Publication
(10) Pub. No.: US 2009/0118912 A1
(43) Pub. Date: May 7, 2009

(54) ENGINE CONTROL SYSTEM OF A SELF-PROPELLED WORKING MACHINE

(76) Inventors: Ludger Hugenroth, Ostbevern (DE); Thomas Zegota, Harsewinkel (DE); Michael Haverkamp, Ostbevern (DE); Jan-Willem Verhorst, Lippsatdt (DE)

Correspondence Address: Striker, Striker & Stenby, 103 East Neck Road, Huntington, NY, 11743, US

(21) Appl. No.: 12/261,178

(22) Filed: Oct. 30, 2008

(30) Foreign Application Priority Data
Nov. 7, 2007 (DE) 10 2007 053 436.3

(51) Int. Cl. B60W 10/06; G06F 17/00; B60W 10/10

(52) U.S. Cl. 701/50; 701/102; 701/54

(57) ABSTRACT

In an engine control system of a self-propelled working machine, a method for operating an engine control system of this type, and a self-propelled working machine equipped with at least one drive engine—the rotational speed of which may be regulated—and working units that are driven in such a manner that their rotational speeds are adjustable, with which the engine speed is regulated as a function of the load on the drive engine(s), and the at least one drive engine is coupled with one or more working units via a drive train, the drive train includes at least one gearbox stage that holds the drive speed of the working unit(s) constant, and the at least one gearbox stage is designed as a mechanical-mechanical power-split transmission. Thereby the drive engine may be operated in a fuel-saving rotational speed range without this affecting the working speeds of the working units.

### CROSS-REFERENCE TO RELATED APPLICATION

The invention described and claimed hereinbelow is also described in German Patent Applications DE 10 2007 053 436.3 filed on Nov. 7, 2007. This German Patent Application, whose subject matter is incorporated here by reference, provides the basis for a claim of priority of invention under 35 U.S.C. 119(a)-(d).

### BACKGROUND OF THE INVENTION

The present invention relates to an engine control system of a self-propelled working machine, a method for operating an engine control system of this type, and an application of this engine control system in a method.

Publication DE 38 10 724 makes known an engine control system that is designed to ensure that—when the drive engine is operated in a partial load range at a lower engine speed in order to save fuel—the working units always operate at a constant rotational speed, regardless of whether the drive engine is operated at a higher or lower engine speed. In a first embodiment, publication DE 38 10 724 proposes a structure in which a torque converter is assigned to each working unit in a decentralized manner, thereby making it possible to adapt every working unit to the changed engine speed in an individualized manner. In addition to the high costs required to include the decentralized torque converters, a complex control system is also required, since every working unit must be monitored separately and controlled in a defined manner.

For this reason, the document proposes—in a further embodiment—to provide a single, centralized transmission block, which is located directly in the drive train between the drive engine and the large number of working units, i.e., the consumers, and to immediately adapt the rotational speed of the drive train to the changed engine speed using a suitable electronic control device. In this case, the central transmission is designed as a power shift transmission. A design of this type has the advantage that the working units do not need to be decoupled during the shifting process. Due to the limited switching stages of a power shift transmission, the engine speed may be changed only in a limited manner.

In contrast, publication EP 1 609 349 discloses an engine-speed control device, with which the output shaft of the drive engine is coupled directly with the sun gear of a planetary gear set, while a hydromotor coupled with an internal gear brings about a change in the rotational speed of the output shaft of the planetary gear set. By coupling the planetary gear set directly with the drive engine and a hydraulic drive, the structure of a hydraulic-mechanical power-split transmission is obtained, the efficiency of which is markedly lower than that of a purely mechanical energy transmission, due to the power losses that occur in the hydraulic branch. As a result, the drive engine must be operated in a torque range that regularly also requires a higher nominal speed range of the drive engine, which ultimately results in higher fuel consumption.

### SUMMARY OF THE INVENTION

The object of the present invention, therefore, is to avoid the described disadvantages of the related art and, in particular, to provide an engine control system for self-propelled working machines that results in an optimal operation of a drive engine with low fuel consumption.

In keeping with these objects and with others which will become apparent hereinafter, one feature of the present invention resides, briefly stated in an engine control system of a self-propelled working machine with at least one drive engine—the rotational speed of which may be regulated—and working units that are driven in such a manner that their rotational speeds are adjustable, and with which the engine speed is regulated as a function of the load on the drive engine(s), and the at least one drive engine is coupled with one or more working units via a drive train, and the drive train includes at least one gearbox stage that holds the drive speed of the working unit(s) constant, wherein the at least one gearbox stage (24) is designed as a mechanical-mechanical power-split transmission (25).

Another feature of the present invention resides in a method for operating an engine control system of a self-propelled working machine with at least one drive engine—the rotational speed of which may be regulated—and working units that are driven in such a manner that their rotational speeds are adjustable, and with which the engine speed is regulated as a function of the load on the drive engine(s), and the at least one drive engine is coupled with one or more working units via a drive train, and the drive train includes at least one gearbox stage that holds the drive speed of the working unit(s) constant, wherein the engine control system holds the engine speed (nmot) of the at least one drive engine (14) constant until a power requirement threshold (55) is reached and, when this power requirement threshold (55) is exceeded, a shift to the next engine speed stage (nmot1, nmot2) takes place.

Given that the engine control system of a self-propelled working machine is coupled with at least one drive engine—the rotational speed of which may be regulated—and working units that are driven in such a manner that their rotational speeds are adjustable, and that are coupled with the drive engine via a drive train, and given that the drive train includes at least one gearbox stage that holds the drive speed of the working unit(s) constant due to the fact that the at least one gearbox stage is designed as a mechanical-mechanical power-split transmission, it is ensured that the drive engine may be operated in a fuel-saving speed range without this affecting the working speeds of the working units.

In an advantageous embodiment of the present invention, the input shaft of the gearbox stage is coupled with the output shaft of the at least one drive motor, and the output shaft of the gearbox stage is coupled with the drive train of at least one working unit; a change in the engine speed results in a change in the rotational speed of the output shaft of the gearbox stage, and the rotational speed of the output shaft of the gearbox stage is adapted within a rotational speed range in a stepless manner. An embodiment of this type has the advantages, in particular, that the output speed of the output shaft of the gearbox stage may be held constant across a large engine speed range, and that the engine speed may be changed in any speed stage.

An embodiment of the steplessly variable, mechanical-mechanical power-split transmission that is technically simple to realize is obtained when the power-split transmission includes a pulling-means gearbox for transferring—at a constant rotational speed—a component of the drive power, and a continuously variable transmission for transferring—at variable rotational speeds—a further component of the drive power, the power components being combined in a summing transmission of the mechanical-mechanical power-split transmission. A high level of functional reliability of the gearbox stage is advantageously attained by using proven transmission structures, namely that the pulling-means gearbox is designed as a belt drive, the continuously variable transmission is designed as a variator drive, and the summing transmission is designed as a planetary gear set.

A very compact embodiment that requires few transmission components results when the pulley of the pulling-means gearbox assigned to the output shaft of the transmission is non-rotatably connected with the internal gear of the planetary gear set, and the variator disk of the variator transmission assigned to the output shaft of the transmission is non-rotatably connected with the planet carrier—on which the planetary gears are mounted—of the planetary gear set, and when the further pulley of the pulling-means gearbox and the further variator disk of the variator transmission are non-rotatably coupled with the output shaft of the at least one drive motor. In this manner, a separate transmission input shaft and intermediate transmission elements become unnecessary.

From the perspective of prefabricating modules, it may be advantageous, however—according to an advantageous refinement of the present invention—for the further pulley of the pulling-means gearbox—which is non-rotatably coupled with the output shaft of the at least one drive engine—and for the further variator disk of the variator transmission to be non-rotatably connected—via an input shaft assigned to a gearbox stage—with the output shaft of the at least one drive engine. In this manner, the inventive transmission may be prefabricated as a separate assembly independently of the other components.

To enable the adjustment of the engine speed to be carried out in a largely automated manner, it is provided in a further advantageous embodiment of the present invention for a control and regulating unit to be provided that ascertains the power requirement of the drive train and/or the working units and, with consideration for the engine characteristics, the fuel-consumption characteristics of the drive engine(s), and the required engine output, implements an engine speed in the partial-load range with the lowest specific fuel consumption.

In the simplest case, a nearly constant output speed of the output shaft of the gearbox stage is attained by lowering or raising the rotational speed of the output shaft of the at least one gearbox stage in the same ratio by which the engine speed is raised or lowered.

Depending on the amount of installation space available and the distances to be bridged between the drive engine and the working units, it may be provided in a further advantageous embodiment of the present invention that the power-split transmission includes a pulling-means gearbox designed as a toothed gearset for transferring—at a constant rotational speed—a component of the drive power, and a continuously variable transmission designed as a chain torque converter for transferring—at variable rotational speeds—a further component of the drive power, the power components being combined in a summing transmission of the power-split transmission.

It is also feasible for a continuously variable transmission for adjusting rotational speed to be assigned to each working unit, so that each working unit may be adapted to the change in engine speed in an individualized manner, thereby ultimately eliminating the need for a cost-intensive summing transmission.

Given that the engine control system holds the engine speed of the at least one drive engine constant until a power requirement threshold value is reached and, when this power requirement threshold is exceeded, switches to the next engine speed stage, it is ensured that a nearly constant output speed at the output shaft of the gearbox stage is maintained using a minimum number of speed changes.

To ensure that the drive engine never stalls, even when brief peak loads occur at the various working units, it is provided in an advantageous embodiment of the present invention that the power requirement threshold value is below the regulating characteristic of the particular drive engine. The power requirement threshold value is preferably approximately 20% lower than the regulating characteristic of the particular drive engine.

Depending on whether the drive engine is underloaded or overloaded at its momentary operating point, it is provided in an advantageous embodiment of the present invention that a switch is made to a higher or lower engine speed—depending on the power requirement—when the power requirement threshold value is reached. The changes in engine speed and, therefore, the rotational speed of the continuously variable transmission, are advantageously carried out via the engine control unit and/or the control and regulating unit.

To ensure—in an advantageous embodiment of the present invention—that the efficiency of the entire usable engine speed range is as high as possible, the power component of the continuously variable transmission decreases as the engine speed increases.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows an inventive self-propelled working machine designed as a combine harvester.

FIG. 2 shows a schematic illustration of the inventive drive train structure.

FIG. 3 shows an illustration of the inventive method based on an engine characteristic diagram.

### DESCRIPTION OF THE PREFERRED EMBODIMENTS

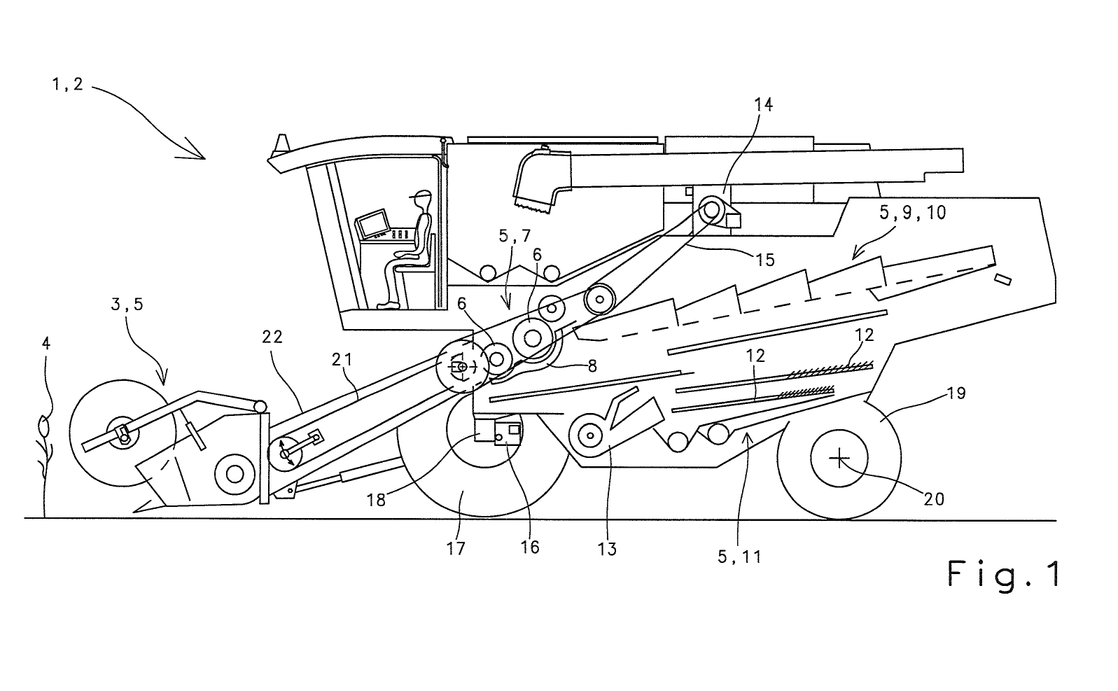

FIG. 1 shows a self-propelled working machine 1 designed as a combine harvester 2, which includes—in a manner known per se—a grain-cutting device 3 located on the front, which is used to harvest and convey crop material 4. To process crop material 4, combine harvester 2 includes highly diverse working units 5, which include, in the exemplary embodiment shown, a threshing part 7 composed of one or more cylinders 6 that are partially enclosed by concaves 8, a separating device 10 that is located downstream of threshing part 7 and is designed as a tray-type shaker 9, and a cleaning device 11 assigned to separating device 10 on the underside. While threshing part 7 and/or separating device 10 may be designed as axial rotors—which are known per se and are not shown here—, cleaning device 11 is typically composed of several oscillating sieve levels 12 and a cleaning fan 13 assigned thereto.

Combine harvester 2 also includes at least one drive engine 14, which supplies—via a drive train structure 15 to be described in greater detail—the drive energy to working units 5 and a ground drive 16—which is not described in greater detail—to drive land wheels 17 of front axle 18 and/or land wheels 19 of rear axle 20. Working units 5, which are also driven by drive engine 14, also include grain-cutting device 3, and feed rake unit 21 of a feed rake 22 located upstream of threshing part 7.

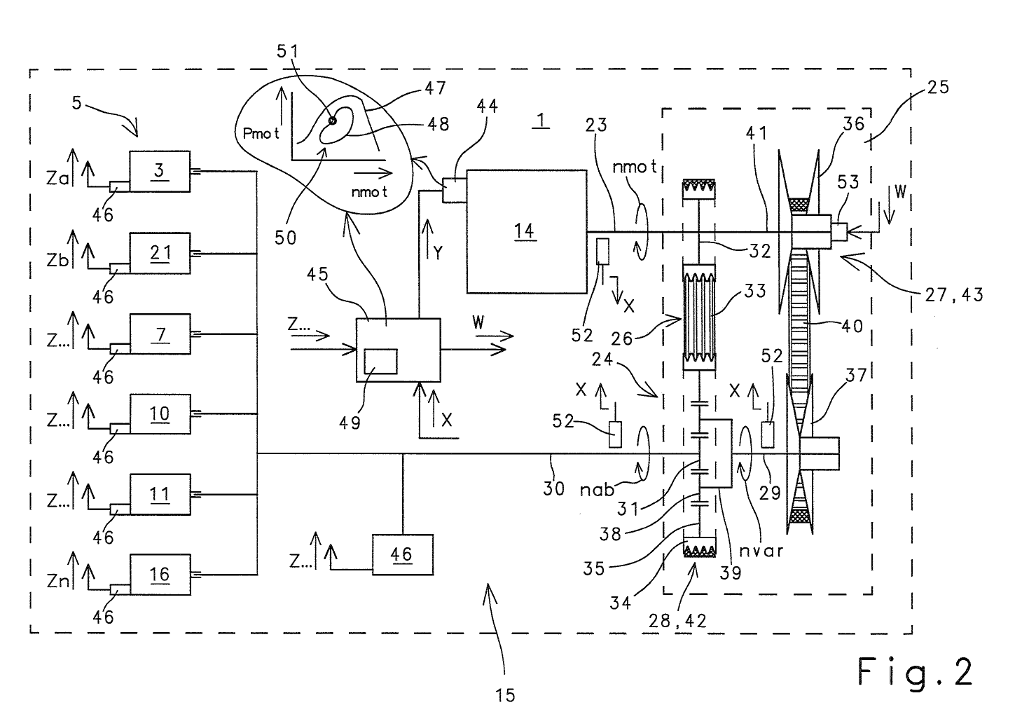

FIG. 2 provides a more detailed description of the present invention based on a schematic illustration of drive train structure 15. Gearbox stage 24—which is designed as a mechanical-mechanical power-split transmission 25 and will be described in greater detail below—is assigned to output shaft 23 of the at least one drive engine 14. Mechanical-mechanical power-split transmission 25 includes a pulling-means gearbox 26, a variator drive 27, and, on the output side, a planetary gear set 28 mounted on an intermediate shaft 29. Output shaft 30 of gearbox stage 24 is non-rotatably connected with sun gear 31 of planetary gear set 28.

A pulley 32 of pulling-means gearbox 26 is non-rotatably connected with output shaft 23 of drive engine 14. Pulley 34—which guides pulling means 33 designed as a composite belt—of pulling-means gearbox 26 is non-rotatably connected with internal gear 35 of planetary gear set 28. Pulling-means gearbox 26 therefore transfers its power component—which it obtains from drive motor 14—directly to internal gear 35 of planetary gear set 28. It is within the scope of the present invention for the outer contour of internal gear 35 to be designed directly as pulley 34. In addition, a pulley 36 of variator drive 27 is non-rotatably assigned to output shaft 23 of drive engine 14. Further pulley 37 of variator drive 27 is non-rotatably connected with intermediate shaft 29 of inventive gearbox stage 24, which is simultaneously coupled in a non-rotatable manner with planet carrier 39 that accommodates planetary gears 38, thereby enabling the power component of drive engine 14 transmitted via composite V-belt 40 of variator drive 27 to be transmitted directly via planetary gears 38 to sun gear 31 and, therefore, to output shaft 30 of inventive gearbox stage 24.

Gearbox stage 24 is therefore designed such that it introduced—via pulling-means gearbox 26—a power component of drive engine 14 with engine speed nmot into planetary gear set 28, which serves as a summing transmission 42, while variator drive 27, which acts as continuously variable transmission 43, may vary the power component of drive engine 14 that was introduced into planetary gear set 28 at rotational speed nvar. Given that internal gear 35 of planetary gear set 28 engages with planetary gears 38, and that planetary gears 38 engage with sun gear 31, the rotational speed nab of output shaft 30 of gearbox stage 24 may be adjusted such that output shaft 30 of gearbox stage 24 always rotates at a constant rotational speed nab, independently of the change in engine speed nmot, and the engine output is ultimately transmitted mechanically. This is made possible by the fact that variator drive 27 may change variator speed nvar in a stepless manner within a certain range.

It is within the scope of the present invention for pulleys 32, 36 assigned to drive motor 14 to be non-rotatably located—as described—directly on output shaft 23 of drive engine 14, or, in another embodiment, for pulleys 32, 36 to be located on an input shaft 41 of gearbox stage 24. In the latter case, input shaft 41 of gearbox stage 24 is non-rotatably connected with output shaft 23 of drive engine 14.

FIG. 2 shows a schematic design of drive train structure 15, which connects the output shaft of inventive gearbox stage 30 with various working units 5 of self-propelled working machine 1. In a manner known per se, drive train structure 15 may include mechanical, hydraulic, and/or electrical energy-transmission elements for driving various working units 5. In the exemplary embodiment shown, which is a combine harvester 2, the various working units 5 include grain-cutting device 3, feed-rake device 21, threshing parts 7, separating device 10, cleaning device 11, and ground drive 16. It is within the scope of the present invention for further working devices not described here, e.g., a straw-chopping and distributing device, to be present.

The at least one drive engine 14 includes an engine control unit 44, which communicates with a control and regulating device 45 assigned to self-propelled working machine 1. In a manner known per se, a torque sensor 46, which is known per se, may be assigned to each of the working units 5. Torque sensor 46 generates a power requirement signal Z and transmits it to control and regulating unit 45. It is within the scope of the present invention to provide fewer torque sensors 46—in order to lower costs—for determining the power requirement of agricultural working machine 1. In the simplest case, a single torque sensor 46 for determining the total power requirement of combine harvester 2 is assigned to drive train structure 15.

Depending on the design of engine control unit 44 assigned to drive engine 14 and of control and regulating unit 45 assigned to combine harvester 2, engine characteristics 47 are stored in engine control unit 44 and/or control and regulating unit 45, as are fuel-consumption characteristics 48 as a function of engine output Pmot and the specific fuel consumption. Control and regulating unit 45 also includes a program module 49, which determines—based on power requirement signals Z, and with consideration for engine characteristics 47 and fuel consumption characteristics 48—an engine speed nmot for operating the at least one drive motor 14 that results in an optimal supply of drive energy to working units 5 while ensuring low fuel consumption. This optimized engine speed nmot is transmitted via a control signal Y to engine control unit 44, which then regulates the fuel supply such that the optimal engine speed nmot that was determined is implemented at output shaft 23 of drive engine 14, thereby enabling the drive engine to be operated at an operating point 51 located in partial load range 50.

To ensure that, when engine speed nmot changes, output speed nab at output shaft 30 of inventive gearbox stage 24 remains constant, variator speed nvar must now be increased in the same ratio by which engine speed nmot is reduced, or conversely, variator speed nvar must be lowered in the same ratio by which engine speed nmot is increased. In a preferred embodiment, this may be realized by assigning speed sensors 52—which are known per se and are therefore not described in greater detail—to output shaft 23 of drive engine 14, intermediate shaft 29, and output shaft 30 of mechanical-mechanical power-split transmission 25. Speed sensors 52 generate speed signals X and transmit them to control and regulating device 45. In control and regulating device 45, speed signals X are used to determine variator speed W, which is transmitted to controlling device 53 of variator drive 27, which then opens or closes particular pulley 36, 37, thereby changing variator speed nvar in such a manner that a nearly constant output speed nab exists at output shaft 30 of gearbox stage 24.

It is also within the scope of the present invention for mechanical-mechanical power-split transmission 25 to include a toothed gearset—which is not shown—instead of pulling-means gearbox 26. It is also feasible to use, instead of the variator drive, a chain torque converter, which is known per se and is therefore not described here in detail, in order to obtain the effects described here, i.e., changing engine speed nmot while holding output speed nab at output shaft 30 of inventive gearbox stage 24 nearly constant. Mechanical-mechanical power-split transmission 25 may also have a decentralized design such that at least one continuously variable transmission 43 is assigned to particular working unit 5 in a decentralized manner. This would have the advantage that a summing transmission 42 would be eliminated, and the variator drives of working units 5—which are present anyway—could be used to adjust rotational speed in an individualized manner. In addition, with an embodiment of this type, a continuously variable transmission 43 and related speed monitoring and regulating devices would have to be provided for each working unit 5.

When self-propelled working machine 1 is driven on the road, all working units 5 except for ground drive 16 are typically out of operation. In this case, it may also be provided, in a further embodiment, for variator speed nvar to be tapped directly at intermediate shaft 29 of gearbox stage 24 in order to drive the not-shown pump of ground drive 16, and to increase the rotational speed of the supply pump of ground drive 16 such that a sufficient output of the pump is ensured even when engine speed nmot is low.

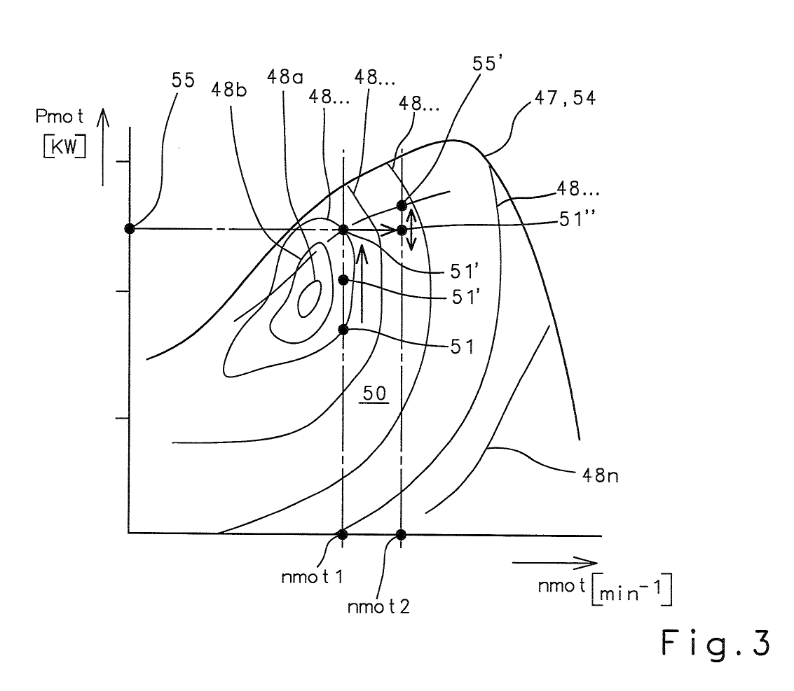

FIG. 3 describes the inventive method based on a detailed illustration of an engine map. The diagram shows—as a function of engine output Pmot and engine speed nmot—an engine characteristic 47—regulating characteristic 54 in this case—and a large number of fuel-consumption characteristics 48. In this case, the fuel consumption of fuel-consumption characteristic increases from 48a to 48n. According to the inventive method, it is provided that engine speed nmot of the at least one drive engine 14 remains constant in a first engine speed stage nmot1 until a power requirement threshold value 55 is reached and, when power requirement threshold value 55 is exceeded, a switch is made to the next engine speed stage nmot2.

Depending on the power requirement of drive elements 5 of self-propelled working machine 1, drive motor 14 depicted in FIG. 3 is operated at an operating point 51 at engine speed nmot 1. If the power requirement of working units 5 increases—due, e.g., to a higher crop-material throughput to be processed by working units 5 of a combine harvester 2, or due to a rising incline of a territory to be traveled across—operating point 51 of drive motor 14 is shifted to an operating point 51′ with a higher engine output Pmot, while maintaining momentary engine speed nmot1. If momentary operating point 51′ corresponds to power requirement threshold value 55, engine control unit 44—in cooperation with control and regulating unit 45 described above—initiates a shift of operating point 51, 51′ to an operating point 51″ located in engine speed range nmot2. A new power requirement threshold value 55′ is then generated in engine speed range nmot2. In this manner, drive motor 14 may always be operated in a partial load range 50 in which low fuel consumption is ensured.

To prevent the drive engine from stalling due to the use of a power reserve, even when brief peak loads occur, power requirement threshold values 55 are below regulating characteristic 54, and are preferably 20% lower than engine output Pmot, which defines regulating characteristic 54. Depending on required engine output Pmot determined via power requirement signals Z, control and regulating unit 45 described above—in cooperation with engine control unit 44—initiates an automatic shift of the drive engine into the lowest possible engine speed range. Output speed nab of the output shaft of inventive gearbox stage 24 is then kept nearly constant, in the manner described above.

In order to ensure a high level of efficiency of mechanical-mechanical power-split transmission 25 and, therefore, a low fuel consumption of drive engine 14 within a large range of engine speed nmot, the engine power component transmitted by continuously variable transmission 43 decreases as engine speed nmot increases.

It will be understood that each of the elements described above, or two or more together, may also find a useful application in other types of constructions and methods differing from the types described above.

While the invention has been illustrated and described as embodied in an engine control system of a self-propelled working machine, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An engine control system of a self-propelled working machine with at least one drive engine having a regulatable rotational speed and working units driven with adjustable rotational speeds, comprising means for regulating the engine speed as a function of a load of the drive engine; a drive train coupling the at least one drive engine with one or more working units and including at least one gearbox stage that holds a drive speed of the working units constant, wherein the at least one gearbox stage is configured as a mechanical-mechanical power-split transmission.

2. The engine control system of a self-propelled working machine as defined in claim 1, wherein said gearbox stage has an input shaft coupled with an output shaft of the at least one drive engine, and an output shaft coupled with the drive train of at least one of the working units, so that a change in the engine speed results in a change in a rotational speed of the output shaft of the gearbox stage, and the rotational speed of the output shaft of the gearbox stage is adjusted within a rotational speed range in a stepless manner.

3. The engine control system of a self-propelled working machine as defined in claim 1, wherein said mechanical-mechanical power-split transmission includes a pulling-means gearbox for transferring, at a constant rotational speed, a component of a drive power, and a continuously variable transmission for transferring at variable rotational speeds a further component of the drive power, with the power components being combined in a summing transmission of the mechanical-mechanical power-split transmission.

4. The engine control system of a self-propelled working machine as defined in claim 3, wherein said pulling-means gearbox is designed as a belt drive, said continuously variable transmission is configured as a variation drive, and said summing transmission is configured as a planetary gear set.

5. The engine control device of a self-propelled working machine as defined in claim 4, wherein said pulling-means gearbox has a pulley assigned to an output shaft of the gearbox stage and non-rotatably connected with an internal gear of a planetary gear set, said variator drive having a pulley assigned to the output shaft of the gearbox stage and non-rotatably connected with a planet carrier, on which the planetary gears are mounted, of the planetary gear set, and said pulling-means gearbox has a further pulley, said further pulley of said pulling-means gearbox and a further pulley of said variator drive are non-rotatably coupled with an output shaft of the at least one drive engine.

6. The engine control device of a self-propelled working machine as defined in claim 5, wherein said further pulley, which is non-rotatably coupled with the output shaft of the at least one drive engine, of said pulling-means gearbox, and said further pulley of said variator drive are non-rotatably connected via an input shaft assigned to said gearbox stage with said output shaft of said at least one drive engine.

7. The engine control device of a self-propelled working machine as defined in claim 1, further comprising a control and regulating unit for ascertaining a power requirement of the drive train and/or the working units and, with consideration of engine characteristics, fuel-consumption characteristics of the drive engine, and the required engine output, implementing an engine speed in a partial load range with a lowest specific fuel consumption.

8. The engine control device of a self-propelled working machine as defined in claim 3, wherein said continuously variable transmission of the at least one gearbox stage is configured so that its rotational speed is raised or lowered in a same ratio by which an engine speed is raised or lowered.

9. The engine control system of a self-propelled working machine as defined in claim 1, wherein said mechanical-mechanical power-split transmission includes a toothed gearset for transferring at a constant rotational speed a component of a drive power and includes a continuously variable transmission configured as a chain torque converter for transferring at variable rotational speeds a further component of the drive power, with the power components being combined in a summing transmission of the mechanical-mechanical power-split transmission.

10. The engine control system of a self-propelled working machine as defined in claim 1, further comprising a continuously variable transmission for adjusting of a rotational speed and assigned to each working unit in a decentralized manner.

11. A method for operating an engine control system of a self-propelled working machine with at least one drive engine having a regulatable rotational speed and working units driven with adjustable rotational speeds so that an engine speed is regulated as a function of a load on the drive engine, and with the at least one drive engine coupled with one or more working units via a drive train including at least one gearbox stage that holds a drive speed of at least one of the working units constant, the method comprising holding by an engine control system the engine speed of the at least one drive engine constant until a power requirement threshold is reached; and when the power requirement threshold is exceeded, shifting to the next engine speed stage.

12. A method for operating an engine control system of a self-propelled working machine as defined in claim 11; further comprising holding the power requirement threshold below a regulating characteristic of the at least one drive engine.

13. A method for operating an engine control system of a self-propelled working machine as defined in claim 12, further comprising holding the power-requirement threshold approximately 20% lower than the regulating characteristic of the at least one drive engine.

14. A method for operating an engine control system of a self-propelled working machine as defined in claims 11, further comprising providing a shift to a higher or lower engine speed as a function of a power requirement when the power requirement threshold is reached.

15. A method for operating an engine control system of a self-propelled working machine as defined in claim 11, further comprising carrying out a regulation of the engine speed and an adjustment of a rotational speed of a continuously variable transmission by a unit selected from the group consisting of a control unit, a control and regulating unit, and both.

16. A method for operating an engine control system of a self-propelled working machine as defined in claim 11, further comprising decreasing a power component of a continuously variable transmission as an engine speed increases.

17. A self-propelled working machine, comprising an engine control system defined in claim 1.

18. A self-propelled working machine, comprising an engine control system defined in claim 1 and operated in accordance with the method defined in claim 11.
